(19) United States
(12) Patent Application Publication
(10) Pub. No.: US 2006/0293209 A1
(43) Pub. Date: Dec. 28, 2006

(54) O/W type detergent composition with improved transparency

(76) Inventors: Yi-Hua Kao, Banciao City (TW); Guo-Ying Don, Sanchong City (TW)

Correspondence Address: BACON & THOMAS, PLLC, 625 SLATERS LANE, FOURTH FLOOR, ALEXANDRIA, VA, 22314, US

(21) Appl. No.: 11/166,086

(22) Filed: Jun. 27, 2005

(51) Int. Cl. C11D 17/00

(52) U.S. Cl. 510/417

(57) ABSTRACT

The present invention is related to a detergent composition comprising essential oil; at least a surfactant, which is a non-ion surfactant or an anion surfactant; and water, wherein the hydrophile-lipophile balance (HLB) of the surfactant is over 7. The composition is a clear lotion and is useful in sterilizing and bacteriostasis.

### BACKGROUND OF THE INVENTION

1. Field of the Invention

The present invention relates to a detergent composition and, more particularly, to a detergent composition which inhibits the growth of bacteria.

2. Description of Related Art The earliest recorded medical application of a herb, Bencao-Beiyua, was in China at about B.C. 2000. Bencao-Beiyau contains several kinds of natural essential oils which form the chemical defense mechanism of the herb and it is also has strong resisting abilities against bacteria, mold and virus, as well as resisting ability for the invasion from insects and animals. On the other hand, essential oil is an excellent material for air-cleaning by way of filtering or eliminating metal particles and toxins in the air in order to improve the concentration of oxygen, ozone and anions for restraining growth of bacteria and removing the odors from molds, cigarettes and animals. For instance, tea tree oil, it mainly contains Terpinen 4-ol and Cineole. These two compositions mentioned above are major components of natural anti-bacteria solutions containing tea tree oils. The tea tree oil is also capable for controlling the growth of bacteria or molds, cleaning, and comforting and calming as a natural bacteriostasis reagent.

Currently, the cleaning products in the market are commonly provided with both anti-bacteria and cleaning features; however, some difficulties exist in the preparation processes of the cleaning products. For example, bleach has sterilizing ability but low stability since bleach tends to neutralize with air and further loses the ability of bacteriostasis as it is neutralized. Moreover, it is not easy to prepare bleach with a foaming agent by ratio. Besides, the common cleaning products of cosmetics cannot provide sterilizing effects as they are limited by the low emulsifying ability. In recent years, the major cleaning products on the market are products having two functions, i.e. the efficiency of cleaning and bacteriostasis. The mentioned prescription is prepared by using surfactant or machinery in order to form the products of oil in water (o/w) or water in oil (w/o). However, that prescription is provided with short stable time and the diameter of oil particles is relatively large whereby the covered essence is limited in its efficiency. The diameter of oil particles of the mentioned (w/o)(o/w) detergent is usually over 1 μm. Although preparing the detergent in an emulsified form can permit its dissolution in water, the diameter of the oil particles is still too large to achieve the effect of the essential oil. Moreover, because the lotion particle diameter is over 1 μm, the appearance of the lotion is not totally transparent and the emulsification is not lasting. Only if the oil particle is dispersed thoroughly enough to reach the particle diameter to 0.05 μm can the diameter of oil particles be close to the wavelength of light, and the appearance of the lotion is then a transparent dispersing solution. However, the present manufacturing technique of essential oil dispersing methods can only reach the stage of the hydrophilic lotion. The effective appearance of dispersed particles of essential oil still cannot be transparent.

The main shortcoming of the current essential oil solution is improved by using hydrophilic organic reagents as thinners. It is proved that the thinner can improve the shortage of the traditional hydrophilic saponification (e.g. the appearance of solutions is as pale, weak emulsifications and the essential oil is incompletely soluble) through increasing the dispersing index of essential oil. However, the result is a milky solution and the emulsification is not long lasting. Also, the essential oil is not completely dissolvable in water. Moreover, the mentioned thinners are methanol, ethanol, isopropanol, hexanol and ethylene tereph-thalate, which are usually toxic and have negative influences on the environment. Therefore, it is necessary to develop a new dispersing method and an oil dispersing reagent which can achieve smaller dispersing oil particles (e.g. 0.05 μm), and a transparent and low toxicity solution.

Thus, there has been for a long time a market demand for a clear essential oil dispersing lotion to be developed, as well as a clear essential oil dispersing lotion with bacteriostasis. The efficacy of cleansing or bacteriostasis can be enhanced with oil particles smaller than the conventional lotion in a well-dispersed essential oil lotion.

### SUMMARY OF THE INVENTION

The object of the present invention is to provide a transparent O/W type detergent composition with sterilizing and bacteriostasis characteristics, which can not only improve the transparency of the detergent but also lower the environmental pollution and toxicity, as well as providing the essential oil with the ability of anti-bacteria.

The composition of the present invention provide smaller diameter of oil particles, whereby particles are dispersed completely in the water, and further the oily component and the hydrophilic component do not separate easily, such that the use life of the composition is good.

To achieve the object, the present invention includes an essential oil; a surfactant, in which the surfactant is a non-ion surfactant, an anion surfactant, or a combination thereof; and water, wherein the hydrophile-lipophile balance (HLB) (HLB) of the surfactant is over 7.

The composition of the detergent of the present invention is formed preferably as a transparent lotion and the usage of the composition is unlimited, preferably is for sterilizing or bacteriostasis.

In the present invention, the diameter of the essential oil particle is varied, preferably is below 0.1 μm, more preferably is below 0.05 μm; the ratio of the essential oil and the surfactant is 1:1-4; and the mixing volume of the water for the lotion preparing to the essential oil and the surfactant mixture is not limited, preferably is 10-10000.

The essential oil of the present invention is various, any known essential oil in the art can be the material of the present invention, preferably is the essence of pine, ginger, lemon or rose. Since the anion surfactant will lower the efficacy of the oil particles, and the anion surfactant is neutralized by the non-anion surfactant, the surfactant suitable in the present invention can be any known non-ion surfactant or the combination thereof in the field, the preferred ion surfactant of the composition is sorbitan oleate, S-Laurate, S-Palmitate or S-Stearate.

### DETAILED DESCRIPTION OF THE PREFERRED EMBODIMENT

### Example 1

Preparation of pine oil cleansing lotion

25 g essence of pine (about 25% of total solution weight), 75g S-Palmitate (HLB 12.9, 75% of total solution weight) are added into a beaker and stirred at high speed to obtain a pine oil lotion.

The HLB of the lotion is 9.675; the oil lotion is an absolutely transparent solution even after 10 times or 100 times dilution.

### Example 2

Preparation of ginger cleansing lotion:

20 g essence of ginger (20% of total solution weight), 40g S-Laurate (HLB 16.3, 40% of total solution weight) and 40 g S-Stearate (HLB 15.4, 40% of total solution weight) are added into a beaker and stirred at high speed to obtain a ginger oil lotion.

The HLB of the lotion is 12.68; the oil lotion is an absolutely transparent solution even after 10 times or 100 times dilution.

### Example 3

Preparation of lemon cleansing lotion:

20 g essence of lemon (20% of total solution weight), 50 g sorbitan oleate (HLB 12.9, 50% of total solution weight) and 30 g S-Palmitate (HLB 15, 30% of total solution weight) are added into a beaker and stirred at high speed to obtain a lemon oil lotion.

The HLB of the lotion is 10.95; the oil lotion is an absolutely transparent solution even after 10 times or 100 times dilution.

### Example 4

Preparation of rose cleansing lotion:

20 g essence of rose (20% of total solution weight), 60 g sorbitan oleate (HLB 12.9, 60% of total solution weight) and 20 g S-Laurate (HLB 16.3, 20% of total solution weight) are added into a beaker and stirred at high speed to obtain a rose oil lotion.

The HLB of the lotion is 11; the oil lotion is an absolutely transparent solution even after 10 times or 100 times dilution.

The detergent composition of the present invention is mainly applied for detergent composition of sterilizing or bacteriostasis and has a high transparency appearance. The mentioned essential oil cleansing lotion is an absolutely transparent solution even after 10 times or 100 times dilution. In the meantime, essential oil with anti-bacteria can be increasingly added to the lotion in order to enhance the effect of bacteriostasis of the lotion; moreover, decreasing the diameter of oil particles of the composition causes it to disperse in the solution completely and further makes the oily component and the hydrophilic component not separate easily, thereby achieving a long use life. The present invention does not include any highly polluting chemicals or toxic chemical dilute reagents and is thus not only harmless to the environment but also provided with low toxicity and low-irritancy to humans.

Although the present invention has been explained in relation to its preferred embodiment, it is to be understood that many other possible modifications and variations can be made without departing from the spirit and scope of the invention as hereinafter claimed.

What is claimed is:

1. An O/W type detergent composition comprising:
an essential oil;
at least a surfactant, said surfactant is a non-ion surfactant, an anion surfactant, or a combination thereof; and
water;
wherein the hydrophile-lipophile balance (HLB) of said surfactant is over 7.

2. The composition as claimed in claim 1, wherein said essential oil is the essence of pine, ginger, lemon or rose.

3. The composition as claimed in claim 1, wherein the diameter of essential oil particles is under 0.1 μm.

4. The composition as claimed in claim 1, wherein said surfactant is a natural oil surfactant.

5. The composition as claimed in claim 4, wherein said surfactant is sorbitan oleate, S-Laurate, S-Palmitate or S-Stearate.

6. The composition as claimed in claim 1, wherein said composition is a lotion.

7. The composition as claimed in claim 6, wherein said lotion is transparent.

8. The composition as claimed in claim 1, wherein the ratio of said essential oil and said surfactant is 1:1 - 4.

9. The composition as claimed in claim 1, wherein the mixing volume of the water for the composition preparing to the essential oil and the surfactant mixture is 10 - 10000.

10. The composition as claimed in claim 1, wherein said detergent is applied in sterilization or bacteriostasis.
